(19) United States
(12) Patent Application Publication
(10) Pub. No.: US 2022/0316099 A1
(43) Pub. Date: Oct. 6, 2022

(54) LIQUID CRYSTAL CLAD FIBERS

(71) Applicant: Kent State University, Kent, OH (US)

(72) Inventors: John Lawton WEST, Hartville, OH (US); Antal Istvan JAKLI, Kent, OH (US); Dena Mae AGRA-KOOJMAN, Kent, OH (US)

(73) Assignee: Kent State University, Kent, OH (US)

(21) Appl. No.: 17/616,241

(22) PCT Filed: Jun. 3, 2020
(86) PCT No.: PCT/US2020/035828

§ 371 Date: Dec. 3, 2021

Related U.S. Application Data
(60) Provisional application No. 62/856,555, filed on Jun. 3, 2019.

(51) Int. Cl. D01F 8/12; C09K 19/36; C09K 19/54; D01F 8/10; D01D 5/34

(52) U.S. Cl. CPC D01F 8/12; C09K 19/36; C09K 19/544; D01F 8/10; D01D 5/34; C09K 2219/01

(57) ABSTRACT

Fibers are clad with a responsive liquid crystal material and a polymer. The clad fibers may be useful for advanced textiles and wearable sensors.

This application claims the priority benefit of U.S. Provisional Application Ser. No. 62/856,555, filed Jun. 3, 2019, the contents of which are incorporated by reference herein.

### BACKGROUND

The present disclosure relates to liquid crystal clad fibers and methods for making the same.

Liquid crystals are well known for their responsiveness to external stimuli, primarily changing their optical properties in response to applied electric fields (used in flat panel displays), temperature variation, mechanical pressure, the presence of chemicals or biological agents. Although in most of these applications, the liquid crystals are in film form, nature is adept at producing complex fibers often with liquid crystal properties. Spider silk and KEVLAR® are examples where the liquid crystallinity provides extraordinary strength.

Liquid crystals have been incorporated as the core of a fiber using single-needle electrospinning, coaxial electrospinning and airbrushing. The diameter of electrospun and airbrushed fibers is typically less than 10 μm, restricting the diameter of the liquid crystal core to single micron dimensions. Cholesteric liquid crystals are chiral and can have helical pitch in the sub-micrometer range, leading to selective reflection and color depending on the pitch. The few micrometer diameter cores limit the reflectivity from these fibers because 8-10 pitch lengths are required for maximum reflection. Also, mats of these fibers are highly scattering because of the many interfaces. Additionally, these fibers are relatively delicate making it difficult to weave them into conventional fabrics.

It would be desirable to develop new responsive liquid crystal clad fibers and methods for making the same.

### BRIEF DESCRIPTION

Disclosed, in some embodiments, is a clad fiber including: a core; liquid crystals; and a polymeric sheath.

The core may be a monofilament core.

In some embodiments, the core has a diameter in the range of from about 0.1 mm to about 0.3 mm.

The liquid crystals may include a mixture of cholesteric liquid crystals.

In some embodiments, the mixture contains cholesteryl nonanoate, cholesteryl oleyl carbonate, and cholesteryl chloride.

The polymeric sheath may contain polyvinylpyrrolidone.

In some embodiments, the core contains a polyamide.

The liquid crystals may be present in a liquid crystal layer located between the core and the sheath.

In some embodiments, the liquid crystals are in the form of cholesteric liquid crystal spheres inhomogeneously distributed in the polymer sheath.

The core may be a partially flattened core.

In some embodiments, the polymer sheath includes a two-component epoxy of a photocurable glue.

Wearable sensors containing the clad fiber are also disclosed.

Disclosed, in other embodiments, is a process for producing a fiber including: applying liquid crystals to a core; an applying a polymeric sheath to the core.

The process may be a batch process or a continuous process.

In some embodiments, the process further includes drawing the core through a coating apparatus, wherein the liquid crystals are applied by feeding the liquid crystals to the coating apparatus at a first inlet and the polymeric sheath is applied by feeding a polymer composition to the coating apparatus at a second inlet downstream of the first inlet.

The polymer composition may be an aqueous solution.

In some embodiments, the process further includes drying the applied polymer composition.

The process may further include flattening the core prior to the application of the liquid crystals and polymer sheath.

In some embodiments, coating apparatus includes a capillary tube.

Disclosed, in further embodiments, is a process for producing a fiber including: applying a composition comprising liquid crystals and a polymeric material to a core; and drying the composition.

These and other non-limiting characteristics are more particularly described below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a cross-sectional view of a clad fiber in accordance with some embodiments of the present disclosure.

FIG. 2 is a cross-sectional view of a clad fiber in accordance with other embodiments of the present disclosure.

FIG. 3 is a flow chart illustrating a method for forming a clad fiber in accordance with some embodiments of the present disclosure.

FIG. 4 is a flow chart illustrating another method for forming a clad fiber in accordance with some embodiments of the present disclosure.

FIG. 5 is a flow chart illustrating a further method for forming a clad fiber in accordance with some embodiments of the present disclosure.

FIG. 6 schematically illustrates a coating apparatus in accordance with some embodiments of the present disclosure.

### DETAILED DESCRIPTION

The present disclosure may be understood more readily by reference to the following detailed description of desired embodiments included therein. In the following specification and the claims which follow, reference will be made to a number of terms which shall be defined to have the following meanings.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent can be used in practice or testing of the present disclosure. All publications, patent applications, patents, and other references mentioned herein are incorporated by reference in their entirety. The materials, methods, and articles disclosed herein are illustrative only and not intended to be limiting.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases that require the presence of the named ingredients/steps and permit the presence of other ingredients/steps. However, such description should be construed as also describing compositions, mixtures, or processes as “consisting of” and “consisting essentially of” the enumerated ingredients/steps, which allows the presence of only the named ingredients/steps, along with any impurities that might result therefrom, and excludes other ingredients/steps.

Unless indicated to the contrary, the numerical values in the specification should be understood to include numerical values which are the same when reduced to the same number of significant figures and numerical values which differ from the stated value by less than the experimental error of the conventional measurement technique of the type used to determine the particular value.

All ranges disclosed herein are inclusive of the recited endpoint and independently combinable (for example, the range of “from 2 to 10” is inclusive of the endpoints, 2 and 10, and all the intermediate values). The endpoints of the ranges and any values disclosed herein are not limited to the precise range or value; they are sufficiently imprecise to include values approximating these ranges and/or values.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

The present disclosure relates to clad fibers, method for forming the clad fibers, articles containing the clad fibers, and methods for forming the articles. The clad fibers include liquid crystals in the cladding.

In some embodiments, the process includes cladding conventional monofilament fibers with low molecular mass (e.g., less than 500 g/mol) liquid crystals stabilized by an outer polymer sheath. The fibers retain the responsive properties of the liquid crystals in a highly flexible/drapable format. The monofilament core makes these fibers much more rugged with a magnified response to external stimuli when compared to previously known liquid crystal core fibers produced by electrospinning or airbrushing. The sensitivity of the response of individual fibers can be tuned over a broad range by varying the composition of the liquid crystals. Complex fabrics can be easily woven from fibers that respond to different external stimuli, such as temperature variation, chemicals and pressure. The fabrics can be fashioned into garments that can sense and report the state of health or the environment.

In particular embodiments, the clad fibers include cholesteric liquid crystals clad on a black nylon monofilament core. The fiber core may have a diameter in the 0.1-0.3 mm range and may be used for traditional textiles. The core provides mechanical strength and absorbs transmitted light, effectively lowering backscattering and thereby enhancing the contrast of the colored fibers.

Upon application as a uniform film, the liquid crystal cladding film will quickly break into beads. The beads may be barrel-shaped. The beads may have an average size of about 50-150 μm, including about 75-125 μm, about 90-110 μm, and about 100 μm. This occurs in about three seconds for nematic liquid crystals with low viscosity, and about 50 seconds for the more viscous cholesteric liquid crystals. Drawing the liquid crystal clad fiber through an aqueous solution of polymer, such as polyvinylpyrrolidone (PVP) that is immiscible with the liquid crystal before the beading occurs, stabilizes the cladding. This technique can be easily automated in a continuous process.

In some embodiments, the process includes pulling the bare core fiber through a cylinder into which the liquid crystal and polymer solutions are continuously fed. As the solvent evaporates the polymer coating hardens, suppressing the Plateau-Rayleigh instability that results in beading. A simple servo motor can be used to control the drawing speed making the process easy to automate.

Fibers clad with a chiral polymer liquid crystal have been reported. In this case a chiral prepolymer reflecting in the green at room temperature was airbrushed on the fiber followed by polymerization. While brilliantly colored, the resulting fibers do not respond to external stimuli, such as changes in temperature, because the helical pitch of a cholesteric liquid crystal polymer is frozen in the state where the mixture was polymerized. In contrast to this, the liquid crystal clad and polymer dispersed liquid crystal clad fibers are responsive to temperature variations as the low molecular weight liquid crystal retains its fluidity and sensitivity inside the polymer coating. At the same time, they can be woven into fabrics and textiles.

The color variation between blue and red can be set to virtually any practical temperature and range by varying the ratios of up to four chiral liquid crystal compounds. Fibers of different compositions can be woven into various patterns, expanding the sensing capabilities of complex fabrics.

Liquid crystals covered with a thin polymer sheet can also sense Volatile Organic Compounds (VOCs) due to the decrease of the phase transition temperature when LC absorbs VOC. Liquid crystals are not sensitive to water vapor, which has an advantage in wearable application where exposure to humidity is likely. Liquid crystal clad fibers are also expected to be pressure sensitive.

The processes of the present disclosure are compatible with commercially viable continuous coating techniques to fabricate liquid crystal clad fibers that have a magnified response to external stimuli. Importantly, these responses do not require the use of external electric power, therefore no wires and batteries are necessary. The fibers may be woven into a complex fabric, that can be employed in a wide array of sensing applications. For example, they could be made into a diagnostic socks that would provide a visible indication of anomalously low skin temperature, an early indication of a developing and potentially lethal ulcer.

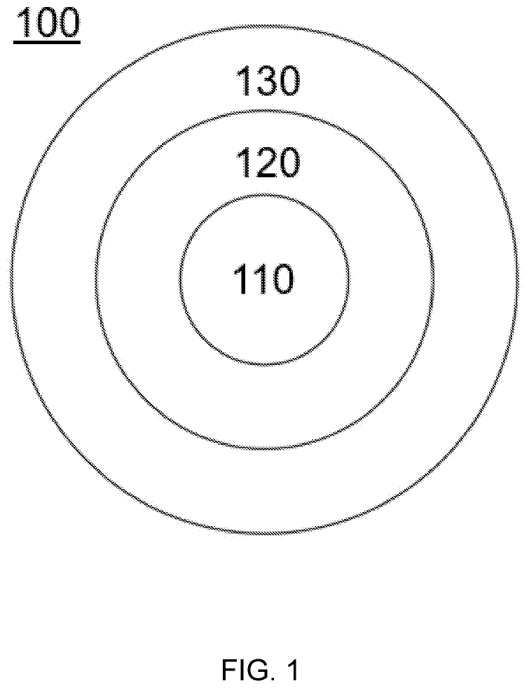

FIG. 1 is a cross-sectional view of a clad fiber 100 in accordance with some embodiments of the present disclosure. The fiber includes a core 110, a liquid crystal layer 120, and a polymeric sheath 130. The core 110 may be a monofilament core or a multifilament core. The core may have a diameter in the range of about 0.1-0.3 mm. The liquid crystal layer 120 may be a cholesteric liquid crystal layer and may contain one or more liquid crystalline materials. The polymeric sheath 130 may function to stabilize the clad fiber 100. The clad fiber 100 may have a diameter in the range of about 2-5 mm.

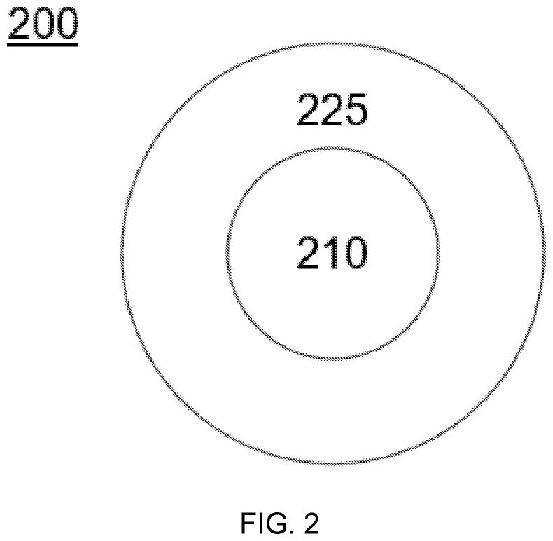

FIG. 2 is a cross-sectional view of a clad fiber 200 in accordance with other embodiments of the present disclosure. The clad fiber 200 includes a core 210 and a cladding layer 225. The cladding layer 225 contains a liquid crystal material and a polymer.

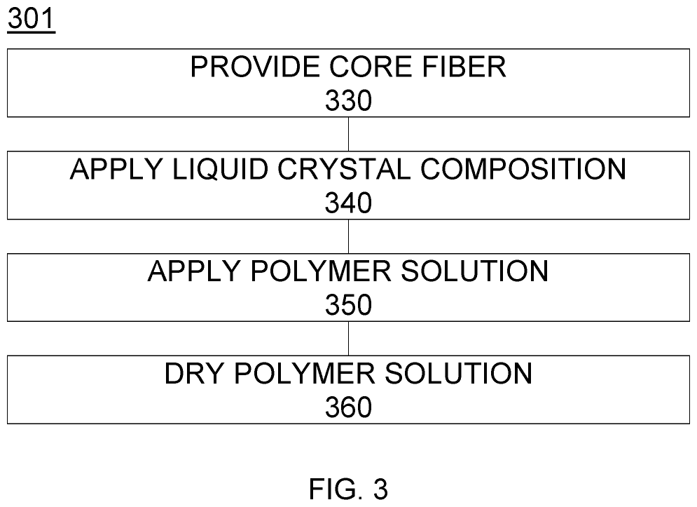

FIG. 3 is a flow chart illustrating a process 301 for producing a clad fiber in accordance with some embodiments of the present disclosure. The process 301 includes providing a core fiber 330, applying a liquid crystal composition 340, applying a polymer solution 350, and drying the polymer solution 360. In this process 301, the liquid crystal composition and the polymer solution are applied sequentially. The process 301 may be a batch process or a continuous process.

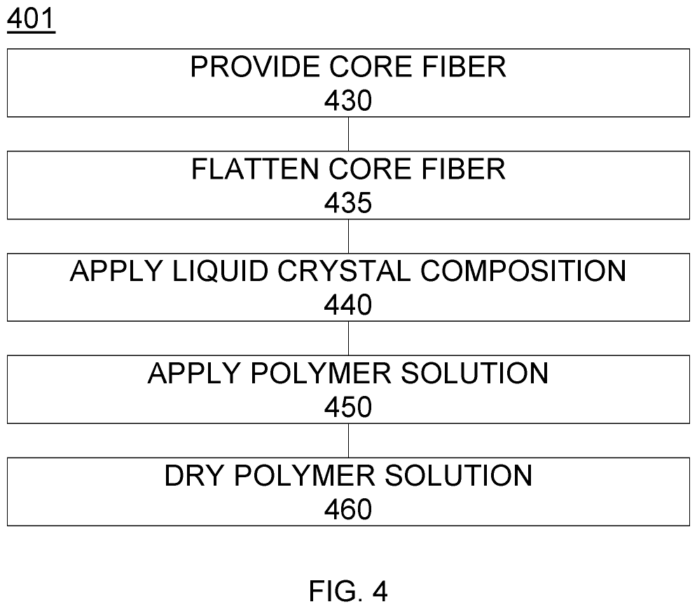

FIG. 4 is a flow chart illustrating a process 401 for producing a clad fiber in accordance with other embodiments of the present disclosure. The process 401 includes providing a core fiber 430, flattening the core fiber 435, applying a liquid crystal composition 440, applying a polymer solution 450, and drying the polymer solution 460. In this process 401, the liquid crystal composition and the polymer solution are applied sequentially. The process 401 may be a batch process or a continuous process. Because of the angular dependence of reflection from cholesteric materials, flattened fibers may be more efficient at reflecting incident light and can be woven into fabrics that show more brilliant colors, for example by braiding. Flattened fibers may reflect color in wider areas and allow for spatial dependence of the reflected color (e.g., by braiding).

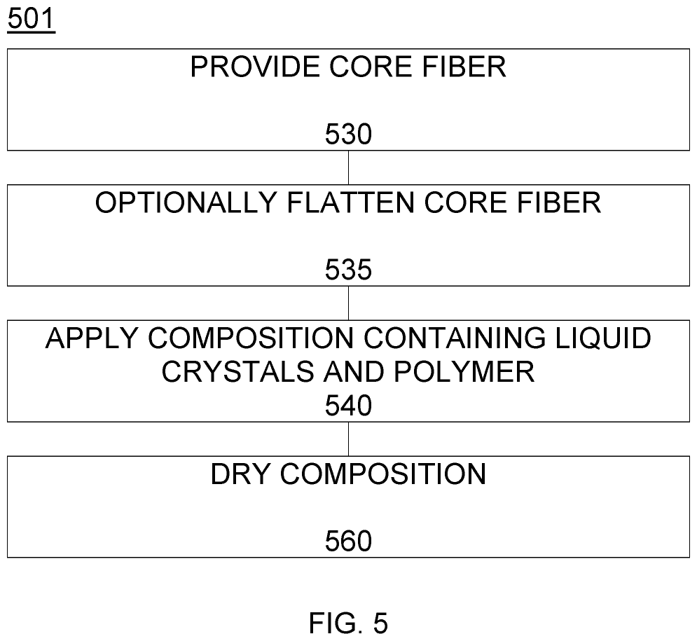

FIG. 5 is a flow chart illustrating a process 501 for producing a clad fiber in accordance with further embodiments of the present disclosure. The process 501 includes providing a core fiber 530, applying a coating composition 540, and drying the coating composition 540. The coating composition contains liquid crystals and a stabilizing polymer. The process 501 may be a batch process or a continuous process. In contrast to the processes of FIGS. 3 and 4, the liquid crystals and stabilizing polymer are applied in the same coating composition in the process of FIG. 5. It should also be understood that the core fiber may be flattened prior to the application of the coating composition although this is not depicted in FIG. 5.

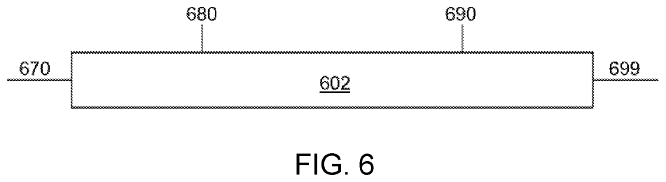

FIG. 6 is a schematic illustration of an apparatus 602 for producing clad fibers in accordance with some embodiments of the present disclosure. The apparatus 602 includes a bare fiber inlet 670, a liquid crystal coating inlet 680, a polymer inlet 690, and a clad fiber outlet 699. The apparatus 602 may have a cylindrical or substantially cylindrical interior. In some embodiments, the apparatus includes a capillary tube through which the core fiber is fed. The core fiber may be fed manually or through an automated process. A motor may be used to draw the fiber through the apparatus. The draw rate of the fiber and/or the feed rates of the coatings may be controlled to produce fibers with a desired coating thickness.

The cores of the fibers may have a circular or substantially circular cross-section. In other embodiments, the cores may have other cross-sectional shapes. The other cross-sectional shapes may be regular or irregular. Non-limiting alternative shapes include rectangles (e.g., squares), triangles, ovals, etc.

The fibers of the present disclosure may be useful for numerous applications including but not limited to advanced textiles and wearable sensors. When the fibers are added to clothing, they may be incorporated during the production of the clothing article or subsequently. Non-limiting examples of clothing articles include shirts, pants, gloves, socks, shoes, patches, etc.

The clad fibers are generally responsive to at least one external stimulus and may exhibit a magnified response compared to known fibers and/or be more durable than existing fibers.

Non-limiting examples of core fiber materials include polyamide fibers, cellulose fibers (e.g., RAYON®), carbon fibers, and polylactic acid fibers. Natural fibers such as cotton, silk, and wool can also be used for the core fiber material.

The polyamide fibers may be derived from monomers including aromatic amide and/or non-aromatic amide.

Non-limiting examples of non-aromatic amide polymers include:

[NH—(CH₂)₅—CO]ₙ;

[NH—(CH₂)₆—NH—CO—(CH₂)—CO]ₙ;

[NH—(CH₂)₆—NH—CO—(CH₂)₄—CO]ₙ—[NH—(CH₂)₅—CO]ₘ; and

[NH—(CH₂)₆—NH—CO—(CH₂)₄—CO]ₙ—[NH—(CH₂)₆—NH—CO—(CH₂)₈—CO]ₘ

wherein m and n are the numbers of repeating units.

Non-limiting examples of aromatic amide polymers include:

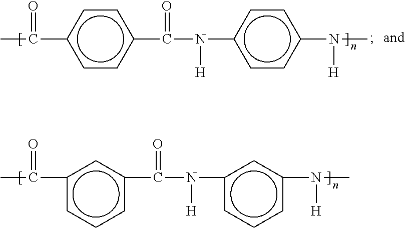

wherein n is the number of repeating units.

The three main liquid crystal phases are the nematic phase, the smectic phase, and the cholesteric phase. In the nematic phase, the liquid crystal molecules have no orderly position but do tend to point in the same direction. In the smectic phase, there is a slight degree of translational order which is not found in the nematic phase.

The cholesteric phase is also known as the chiral nematic phase. In the cholesteric phase, the molecules are aligned at a slight angle and in thin layers. Cholesteric liquid crystal materials typically exhibit color change when exposed to different temperature.

The claddings of the present disclosure generally include at least one cholesteric liquid crystal material that exhibits a response to at least one stimulus (e.g., exposure to a material intended to be sensed by a sensor).

Non-limiting examples of stabilizing materials include polyvinylpyrrolidone, polyvinyl alcohol, polyethylene glycol, epoxies, polyurethanes, and photocurable glues. In some embodiments, the stabilizing polymer is applied in an aqueous solution.

The liquid crystals may be applied to the core fiber in advance of the application of the stabilizing material(s). Alternatively, the liquid crystals and the stabilizing material(s) may be applied in the same composition.

It is also contemplated that multiple responsive materials and/or coating layers may be applied. Each responsive material and/or coating layer may be sensitive to a different stimulus. For example, one material/layer may be responsive to temperature variations while another may be sensitive to a chemical. As another example, different responsive materials/layers may be sensitive to different chemicals.

The differing responsive materials/layers may be applied to the same or different core fibers. For example, it is contemplated that a wearable article may include multiple fibers wherein some of the fibers are responsive to a first stimulus and other fibers are responsive to a second stimulus.

In some embodiments, the stimuli are hazardous materials. The wearable article may be a hazmat suit.

The following examples are provided to illustrate the devices and methods of the present disclosure. The examples are merely illustrative and are not intended to limit the disclosure to the materials, conditions, or process parameters set forth therein.

### EXAMPLES

Liquid crystal clad fibers were produced. Bare fiber was pulled through a capillary tube in which liquid crystals and polymer solutions were fed. The clad fiber included a 200-μm diameter nylon core and the cladding included a cholesteric liquid crystal mixture (cholesteryl nonanoate: cholesteryl Oleyl carbonate: cholesteryl chloride=1:1:0.6) stabilized with a PVP outer sheath. The coated fiber had a helical structure of the liquid crystal director. The cholesteric liquid crystal mixture gave a temperature variation of the color up to about 70° C. Many other mixtures are contemplated depending on the need for the useful temperature range.

Since neither the solvent (water), nor the polymer (PVP) is miscible with the liquid crystal, the polymer formed an external sheath without mixing with the liquid crystal coating. This structure was experimentally verified by Scanning Electron Microscopy (SEM). The liquid crystal mixture was chosen as it shows color variation over a convenient temperature range, and the PVP was chosen as it is not miscible with the CLC and did not required curing. During the SEM preparation the low molecular weight LC evaporates, leaving a gap between the core nylon fiber and PVP sheath. The sharpness of the gap indicated that the PVP layer and the liquid crystal are completely separated. Although SEM cannot determine the alignment of the cholesteric liquid crystals, it was assumed that the director aligned along the core and polymer sheath surfaces and, due to the chirality of the molecules, was twisted radially.

The size and color appearances of a liquid crystal clad single fiber was compared with an electrospun fiber mat consisting of a large number of less than 10 μm diameter fibers, where the same cholesteric liquid crystal makes the core as that makes the clad for the liquid crystal clad fiber. The liquid crystal clad fiber was brightly colored because of the light by the cholesteric liquid crystal mixture, whereas the electrospun fiber mat appears whiteish due to strong light scattering.

The reflection spectra at room temperature for normally incident light for four different structures containing cholesteric liquid crystals were observed. The structures included (a) a 25 μm thick cholesteric liquid crystal cell sandwiched between two glass plates with inner surfaces coated with a rubbed polymer layer that aligns the liquid crystal director parallel to the substrates and the rubbing direction (uniform planar alignment); (b) a 280 μm diameter round liquid crystal clad fiber fabricated as described above with a liquid crystal layer between a nylon core and a PVP sheath; (c) a 0.4 mm wide liquid crystal clad fiber, where the cholesteric liquid crystal was coated on a flattened nylon fiber achieved by warming the fiber above the glass transition and pressing between metal plates; and (d) a round polymer dispersed liquid crystal clad (PDLCC) fiber where the 200 μm nylon fiber is coated by a Polymer Dispersed Liquid Crystal (i.e., liquid crystals and polymer in the same coating composition).

The PDLCC fiber was achieved by a one-step coating process, where the nylon fiber was pulled through a mixture of the CLC, PVP and ethanol in 1:0.3:1.7 ratios. Upon evaporation of the solvent the polymer solidified, and the liquid crystal separated into <10 μm size spheres embedded randomly in the polymer matrix. The reflectance spectrum of the cholesteric liquid crystal cell showed the highest reflection at 530nm. The reflectance of the round liquid crystal clad fiber had a maximum at 518 and the width of the peak was about twice that of the cholesteric liquid crystal film with a tail at shorter wavelengths. The shorter wavelength tail is the result of the incidence angle θ dependence of the reflected light wavelength which varies as λ=λ₀ cos θ, where λ is the observed reflection wavelength, λ₀ is the reflection wavelength for light incident normal to the helical axis and θ is the angle between the incident light and the helical axis. Observed blue shift was the result of the radial distribution of the helical axis around the cylindrical fiber. A top view of a 0.28 mm diameter liquid crystal clad fiber with a circular cross section showed some non-uniformity of the alignment, an indication of a fractured planar texture. For the flattened liquid crystal clad fiber, the spectrum was narrower with a maximum at 522 nm. This is because a much larger fraction of the fiber has the cholesteric liquid crystal helical axis aligned normal to the incident light. For the PDLCC fiber the spectrum was broadest with maximum at 516 nm, due to the reflection coming only from the cholesteric liquid crystal spheres.

The cholesteric liquid crystal cell showed a uniform bright green texture indicating uniform planar alignment. The liquid crystal clad fibers with circular cross section appeared to have less than the 280 μm width as measured with the SEM. The middle region of the fiber was green, but the edges appeared blue. This is due to the viewing angle (θ) dependence of the reflected wavelength λ. For θ<30° the fiber reflects green light (λ>490 nm). For θ>30° the λ decreases rapidly passing through the blue between 30 and 50 degrees. For θ>50° the fiber does not reflect visible light, explaining why it appears narrower. Assuming the ideal radial alignment of the cholesteric helix axis, no reflection is expected when looking at the cross-section. Indeed, the majority of the cross section is black in the bottom, color observed in the upper portion indicates shear produced by cutting that partially realigned the helical axis producing the observed blue reflection. The texture of the flattened fiber showed almost uniform green in accordance with the reflection spectrum. The cross-section now showed color everywhere in the cholesteric liquid crystal area, indicating cutting induced realignment in the entire cross section. The texture of the PDLCC was mainly green with blue shades even in the middle of the fiber due to the inhomogeneous distribution of the small cholesteric liquid crystal spheres in the polymer matrix. The cross-section had green reflection, since the embedded cholesteric liquid crystal spheres have a radial alignment of the helical axis. Even though the reflection was less bright, the PDLCC fibers had the advantage of being slightly easier to make. Additionally, the PDLCC fibers appeared to be more rugged against repeated bending. Although liquid crystal clad fibers can handle gentle deformations, such as weaving, the PVA coating is shed under vigorous and repeated bending.

Three fibers reflecting blue, red and green at room temperature and passing through the visible spectrum over 20-50° C. temperature ranges were evaluated. When heated to 55° C., the blue did not change, while the red shifted to infrared and the green turned reddish. When heated to 70° C. all color shifted to infrared and the fabric was uniformly black.

A preliminary investigation into the washability of different liquid crystal clad fibers has also been conducted demonstrating that the fibers are stable after immersing in water and mild detergent.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

1. A clad fiber comprising:
a core;
liquid crystals; and
a polymeric sheath.

2. The clad fiber of claim 1, wherein the core is a monofilament core.

3. The clad fiber of claim 1, wherein the core has a diameter in the range of from about 0.1 mm to about 0.3 mm.

4. The clad fiber of claim 1, wherein the liquid crystals comprise a mixture of cholesteric liquid crystals.

5. The clad fiber of claim 1, wherein the mixture comprises cholesteryl nonanoate, cholesteryl oleyl carbonate, and cholesteryl chloride.

6. The clad fiber of claim 1, wherein the polymeric sheath comprises polyvinylpyrrolidone.

7. The clad fiber of claim 1, wherein the core comprises a polyamide.

8. The clad fiber of claim 1, wherein the liquid crystals are present in a liquid crystal layer located between the core and the sheath.

9. The clad fiber of claim 1, wherein the liquid crystals are in the form of cholesteric liquid crystal spheres inhomogeneously distributed in the polymer sheath.

10. The clad fiber of claim 1, wherein the core is a flattened core.

11. The clad fiber of claim 1, wherein the polymer sheath comprises a two-component epoxy of a photocurable glue.

12. A wearable sensor comprising the clad fiber of claim 1.

13. A process for producing a fiber comprising:
applying liquid crystals to a core; an
applying a polymeric sheath to the core.

14. The process of claim 13, wherein the process is a continuous process.

15. The process of claim 13, further comprising:
drawing the core through a coating apparatus;
wherein the liquid crystals are applied by feeding the liquid crystals to the coating apparatus at a first inlet; and
wherein the polymeric sheath is applied by feeding a polymer composition to the coating apparatus at a second inlet downstream of the first inlet.

16. The process of claim 15, wherein polymer composition is an aqueous solution.

17. The process of claim 15, further comprising:
drying the applied polymer composition.

18. The process of claim 13, further comprising:
flattening the core prior to the application of the liquid crystals and polymer sheath.

19. The process of claim 14, wherein the coating apparatus comprises a capillary tube.

20. A process for producing a fiber comprising:
applying a composition comprising liquid crystals and a polymeric material to a core; and
drying the composition.
